(19) United States
(12) Patent Application Publication
(10) Pub. No.: US 2021/0061636 A1
(43) Pub. Date: Mar. 4, 2021

(54) Valve and Method for Gasifying Liquids and Dispensing Gasified Liquids

(71) Applicant: Heber Frizera Ferreira, Assis Chateaubriand (BR)

(72) Inventors: Heber Frizera Ferreira, Assis Chateaubriand (BR); Flavio Henn Ferreira, Sao Paulo (BR); Rodrigo Cesar Dos Santos, Santo Andre (BR); Walter Lebante, Santo Andre (BR); Ana Lucia Domingues De Oliveira, Santo Andre (BR)

(21) Appl. No.: 16/957,266

(22) PCT Filed: Dec. 17, 2018
(86) PCT No.: PCT/BR2018/050466

§ 371 Date: Jun. 23, 2020

(30) Foreign Application Priority Data
Dec. 28, 2017 (BR) 10 2017 028540 5

(51) Int. Cl. B67D 1/00; B67D 1/14

(52) U.S. Cl. CPC B67D 1/0071; B67D 1/1405

(57) ABSTRACT

This invention relates to a valve for gasifying liquids and dispensing gasified liquids, comprising a main body (7) which comprises an air valve (3) interconnected to an inner channel (3a), said valve consisting of a nozzle which comprises a universal thread (10) and a cylindrical piece (11a) which connects through means of connection to a reductant (4), and this reductant (4) connecting to a liquid outlet pipe (5), said reductant (4) connects to a flexible hose arranged “in L” (6) which is internally positioned to the tubular extension (2), said flexible hose (6) is arranged between the main body (7) and a handle (1) which pivots with the main body (7) through metallic rod (9c), said pipe (5) comprises another reductant (41). In particular, said valve is compatible with the nozzle of any bottle or growler with the universal thread and it allows gasifying and dispensing with flow control and controlled generation of foam in gasified liquids, such as chopp, sparkling wine, among others in locations other than those the gasification occurred.

### FIELD OF THE INVENTION

This invention relates to valves for dispensing liquid. In particular, this invention relates to a valve for dispensing gasified liquid. In particular, one of the uses of said valve is coupled with small, portable packaging.

### BACKGROUND OF THE INVENTION

Currently, existing devices for storing and dispensing gasified beverages, especially alcoholic beverages such as chopp, in smaller containers have been largely highlighting because they provide a new form of consumption, with portability as their large differential. These containers are commonly called as “growlers” and are generally glass, ceramic or plastic and have the advantage of enabling transport of the gasified beverage to the location chosen by the user. Thus, the user who consumes the chopp is not limited to the location serving the chopp, a bar, restaurant, or other type of commercial establishment, but the user may, for example, consume the beverage in a camping or even at high sea during fishing.

However, although such containers enable transport, they still do not ensure perfectly taking the beverage, since they do not prevent loss of gas over time. Thus, the sensory quality of the beverage is lost over time due to de-carbonation and the shape and consistency of the chopp foam taken by such containers in most times is not the same as when the beverage is taken by a bar practitioner.

It is well-known that the relevance of the foam to the consumer of chopp or other type of beverage and current “growlers” does not allow taking the quality foam.

In a system for taking “balanced” beer, the beer is served with dissolved gas levels near the levels in which it has been produced, that is, its sensory quality is not compromised by taking it.

In this regard, “growlers” available in the market have not solved this challenge: they are used only as containers with no aggregate functionality. There are still great technical challenges to overcome, some of them: the sealing, an efficient process of gasification, the maintenance of the gasification of the beverage over time, customization of the creamy of the beverage, giving the consumer the possibility of choosing the quantity of foam and liquid to be served, exposing the beverage to air, which accelerates its degradation, and is of possible use only at room pressure.

The patent literature provides some relevant documents which will be described below.

The document BR102014025747-0 refers to a valve for dispensing gasified liquids such as beverages, comprising an inlet nozzle for gasifying the beverage. Said valve comprises a duct that remains immersed in the liquid and a screw that may be a universal thread. Said valve differs from the valve according to this invention, in which it does not comprise a control device of the beverage dispensing mode and sealing devices that decrease the pressure of solubilized gas in the liquid, as well as the customized and controlled generation of foam.

The document US 2015/0274501 refers to a valve for growlers having a pressure relief valve, a gas load location and an immersion pipe in the beverage. Said valve differs from the valve according to this invention, in which it does not comprise or suggest a reducing device according to this invention that reduces the pressure of the liquid as it passes through the pipe at the time of dispensing thereof, nor a mechanism for gasification/injection of gas into the container that allows reuse of the apparatus.

The document WO 2016/159795 describes a valve for packages containing carbonated beverages that comprises a manual lever device to be driven by the user and a pressure reductant positioned at the liquid outlet. Said valve differs from this invention, in which it does not comprise a device for the gasifying the beverage that allows for reuse of the apparatus, and is, unlike this invention, a valve that does not have high efficiency in carbonation, since the container must already contain the gasified liquid, and not the liquid to be gasified according to this invention, and it does not comprise or suggest a reducing device as according to this invention that reduces the pressure of the liquid as it passes through the pipe at the time of dispensing thereof.

The document WO 2016/026694 refers to a valve for dispensing an alcoholic beverage comprising a 2-gear system that operate jointly and whose beverage delivery mechanism is carried out by turning it. It differs from this invention in which it does not comprise a handle with a twist of 60°, reducing or a device gasifying the beverage.

The document U.S. Pat. No. 9,533,865B2 refers to a device for dispensing beer comprising in a single apparatus a beverage carbonation device and a dispensing mechanism, including a liquid internal level display device. The beverage dispensing mechanism can eventually be detached from the container and used alone. However, it differs from this invention in which even detached from the device, it does not comprise a locking mechanism of the new container as according to this invention or a mechanism that allows for easy injection of gas into the container that allows reuse of the apparatus.

The documents US 2013/0233878 and US 2013/0233895 describe a valve for dispensing carbonated beverage comprising a handle whose movement in approximately 90° allows for the release of the beverage. Such valves differ from this invention in which it does not comprise pressure reductants positioned in the beverage outlet path, nor a mechanism for gasifying/injecting gas into the container that allows reuse of the apparatus.

### SUMMARY

In view of the foregoing, the inventors of this invention have developed a valve that allows for the perfect dispensing the chopp and the consequent formation of the customized foam at the location where the consumer is, either inside the home or, for example, at the top of a mountain.

This invention comprises a valve comprising a handle (1) which pivots with a main body (7) which comprises an air valve (3), type of schrader valve, for the insertion of gas, said main body comprising an internal thread (10) compatible with the nozzle of the growler or the container where the beverage is to be gasified, wherein concentric to this nozzle is a cylinder (11a) and (11b) which connects with a reductant (4) that simultaneously connects to a flexible hose arranged “in L” (6) and a liquid outlet pipe (5) which comes in direct contact with the liquid and the lower end of which comprises another reductant (41) wherein the other end of the flexible hose arranged in “L” (6) is positioned at the end of the extension (2) by where the liquid is dispensed.

Said air valve (3) operates in conjunction with the CO₂ or N₂ gas cylinder, or a mixture thereof, which gasifies the beverage. After gasification, the valve is disconnected from the gas system.

In particular, the valve according to this invention provides a universal screw which enables the fitting in any type of nozzle of the growler or the container with a universal screw containing the beverage.

In particular, the valve according to this invention comprises the use of a nozzle for the insertion of gas, known as schrader valve, which is used in a tubeless automobile tire, which ensures the preservation of gasification of the beverage even after several days of its packaging, allowing a good quality of the chopp taken after several days.

In particular, a good taken beverage may be obtained after more than 30 days of its gasification in the growler.

The valve according to this invention allows customization of the foam by the user. The well-known “head” of the beverage may be less or more robust as the taste of the user.

The invention disclosed herein acts in the solution of these technological challenges, since both allows consumption to occur under the condition of the freshly-gasified beverage, and allows portability of the consumption of the gasified beverage maintaining the sensory quality of the beverage more efficiently than existing devices commercially available today.

The valve of this invention may be used in any type of container, either in the portable containers or in fixed containers.

Said valve is useful in dispensing any gasified liquid such as sparkling wine, sparkling water, fizzy juice, soft drink, chopp, beer, among other liquids of interest as well as mixing thereof.

Said valve further has a locking mechanism that allows for the transport of the container safely and properly without the need for decoupling the valve to the container.

This invention further comprises a process for dispensing gasified liquid comprising the use of said valve.

This invention has the advantage of the possibility of making easy the gas injection without the need for pressurizers, in addition to the possibility of reusing the apparatus, valve and container, and the fact that it is low cost, potentially disposable.

### BRIEF DESCRIPTION OF THE FIGURES

To complement the description of the invention in order to provide a better understanding of the purpose, the figures mentioned throughout the specification will be described below.

FIG. 1 shows the exploded view of the components of the valve comprising a handle (1) which pivots with a main body (7) which comprises an extension (2) into which is a flexible hose (6) positioned at “L” in which one of the ends is free and the other is connected to the reductant (4) which is connected to the inner pipe (5).

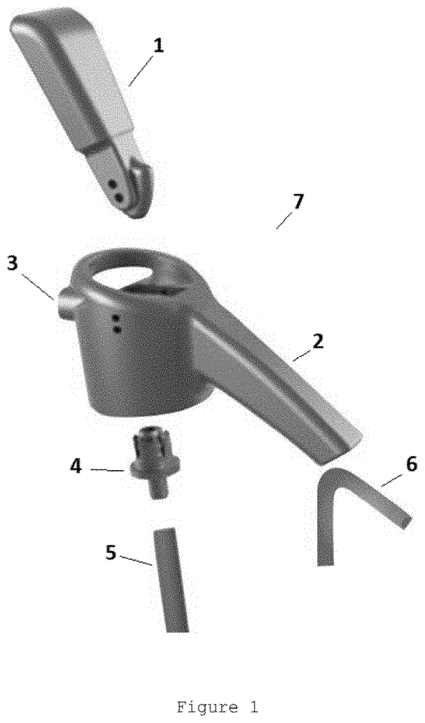

FIG. 2A shows the top view of the main body of the valve (7) showing the hollow semi-ball (8) where it engages the handle (1), 2-holes (9a) which are fitted with metallic rods that allow the pivot of the handle with the main body and the locking of the valve, a schrader air valve (3) and the extension of the valve body (2) by where the gasified liquid is poured. FIGS. 2A-B show the top side view of the main body (7).

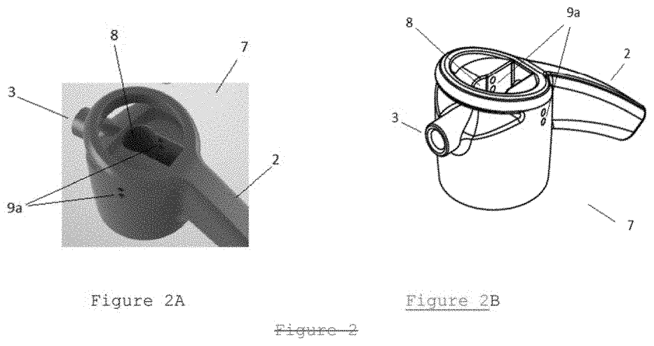

FIG. 3A shows the bottom side view of the main body of the valve (7) showing a nozzle comprising an internal thread (10) compatible with the thread of the growler or container wherein the beverage is stored and concentric with the nozzle a cylindrical piece (11a) whose inner wall (11b) comprises a thread (11b) compatible with the reductant (4). FIG. 3B shows the bottom view of this nozzle.

FIG. 4 shows a handle (1) which comprises a semi-ball (12) at one of the ends and 2-holes (9b) which are compatible with the holes of the main body of the valve (9a).

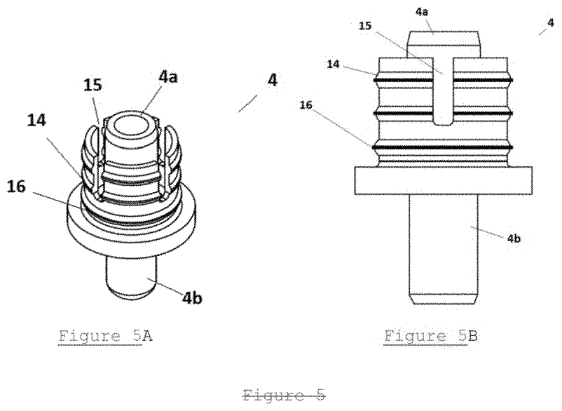

FIG. 5A shows the top side view of the reductant (4) which comprises an upper cylindrical inner piece (4a) in which the flexible hose is connected in “L” (6) and a bottom inner cylindrical piece (4b) connecting the inner pipe (5). Externally the reductant (4) comprises a screw (14) with grooves (15) and rubber rings for sealing (16). This outer thread connects with the inner thread (11b) of the cylindrical piece concentric to the nozzle. FIG. 5B shows the side view of the reductant.

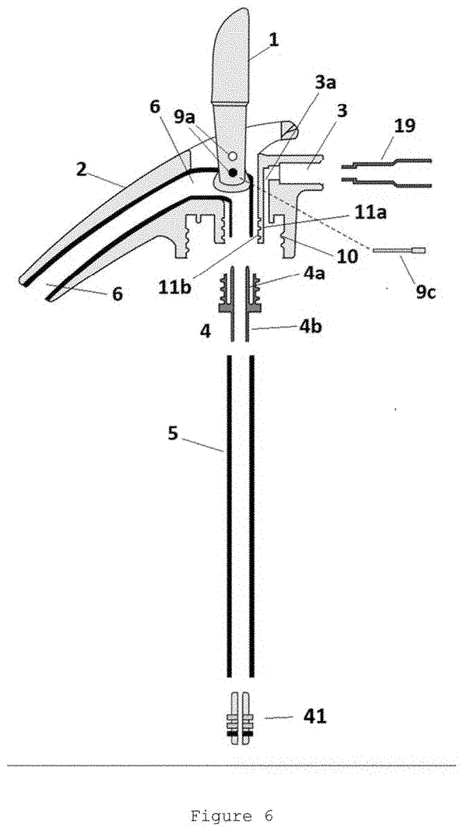

FIG. 6 shows an exploded cross-sectional view of portion of the valve elements according to this invention with special attention on the fitting of the reductant (4) to the cylindrical piece of the nozzle (11a) in the inner thread (11b); one of the metallic rods (9c) passing through the hole (9a) of the body and (9b) of the handle (1); the position of the handle (1) on the flexible hose in “L” (6) so that as the position of the handle (1) is modulated the inner volume of the hose (6); the screw (10) which is compatible with the nozzle of the bottle containing the liquid to be pressurized; the schrader air valve (3) which conducts the gas through an inner channel (3a).

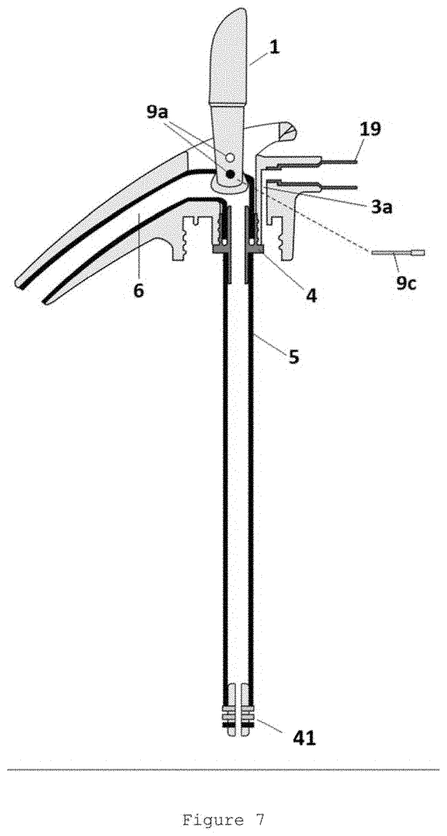

FIG. 7 shows a cross-sectional view of the valve according to this invention with the reductant (4) connected to the nozzle of the valve body and the clamp (19) of the cylinder hose connected to the air valve.

FIG. 8 shows the valve according to this invention positioned in the nozzle of the bottle containing the liquid (18) connected to the hose (20) of the gas cylinder (23) by the schrader air valve (3), and the clamp (19) of the hose as well as the gas cylinder registry (22) which allows, when opened, the gas flow, and the pressure gauge (21).

In general, FIG. 9 shows the valve according to this invention positioned on the nozzle of the container containing the pressurized liquid in which FIG. 9A shows the vertical position of the handle (1) locking the operation of the valve; FIG. 9B shows the position forward in relation to the user allowing the dispensing of the beverage with the formation of a large quantity of foam; and FIG. 9C shows the position backward in relation to the user allowing the dispensing of the beverage with small foaming.

### DETAILED DESCRIPTION OF THE INVENTION

This invention may be embodied based on the following elements, wherein the examples presented herein constitute only examples of the embodiment of the invention without, however, excluding other possible and potentially not described herein but are within the scope of this invention.

The parts of said valve described herein may be manufactured from several materials such as polypropylene plastic or other possible as well as the combination thereof.

The principle of functioning of said valve is based on the fact that the handle (1) comprises a flexible hose positioned internally in the form of “L” (2), wherein such compression occurs at different positions of the handle in a twist of about 60° on the hose generating different inner volumes in the flexible hose (6). For this operation, the top hole must be filled with the metallic rod (9c).

When in the vertical position, 90° in relation to the ground, the handle compresses at the maximum the flexible hose in order to prevent the flow of the beverage. In this position the two handle holes are filled by the metallic rod (9c) and the valve is locked so that the container containing the gasified liquid may be transported without the danger of leakage.

When the handle is moved forward in relation to the user, the hose will undergo a displacement that enables a minimal opening in its diameter so that the flow of the beverage is turbulent and the beverage is dispensed with enough foam.

When the handle is moved backward in relation to the user, the compression of the hose is smaller and consequently the flow of the pressurized beverage is more laminar, allowing the liquid outlet with less quantity of foam.

In this sense, one of the purposes of this invention consists of the method for dispensing gasified liquid comprising the steps of:
i. Unlocking the handle (1);
ii. Positioning the cup or container in which the liquid will be dispensed at the end of the tubular extension (2);
iii. Moving the handle (1) forward or backward in relation to the user;
iv. Waiting for appropriate time; and
v. positioning the handle in the 90° position.

The liquid pressurizing procedure involves the steps of:
i. placing the liquid to be gasified into a suitable container with the valve of this invention installed;
ii. connecting the cylinder hose to the air valve (3) of the valve body (7);
iii. opening the cylinder register (22) allowing the flow of gas from the cylinder to the liquid;
iv. waiting for adequate time;
v. closing cylinder register (22); and
vi. disconnecting the cylinder hose (19) from the air valve (3).

The connection of the cylinder to said valve occurs through a coupling similar to that used in the calibration of automobile tires. A hose (20) is coupled to the cylinder (22) through a screw system and the opposite end comprises a gas injection nozzle comprising a clamp (19) similar to that used in tire air minicompressors as the commercially available SH-P 00004 model. Said clamp (19) fits into the valve body according to this invention directly in a schrader valve (3) which is a valve used in a tubeless automobile tire as the market model 414 R.

Since the ends are properly connected, the cylinder register is opened (22) and the pressurization starts. The gasification may be done with carbon dioxide CO₂ (99.9%), nitrogen N₂ (99.9%), or a mixture thereof.

The gasification time and the final pressure reached indicated in the display (22) will depend on the volume of liquid to be gasified, the type of gas used, the temperature, the material of the container comprising the liquid and the user's interest. If the user desires a thick beer head, it may increase the content of the solubilized gas in the beverage.

In one embodiment, for a 2 L container being 70% filled with the beverage and therefore 30% hollow, the gasification was made at the pressure of 3.5 kgf cm⁻² of CO₂ for 2 seconds, so that the gas pressure (in kgf cm⁻²)×volume of the hollow bottle (as percent of the total volume) is equal to or greater than 1 kgf cm⁻².

This gasification procedure may be done in both the commercial establishment and the home environment, following the proper safety requirements.

Once this step is finished, the cylinder (22) is closed, the hose clamp (19) is disconnected from the schrader air valve (3) and the liquid is ready to be dispensed and consumed.

The use of the schrader valve (3) allows for a high efficiency in the gasification process and the maintenance of the gasification, since it prevents escape of gas during storage and transport of the beverage over time.

### Valve Body (7)

The valve body according to this invention is a single piece which may be plastic, metal or other compatible material.

Said body (7) comprises a nozzle (11) whose inner wall comprises a universal thread (10) compatible with the thread of the container which stores the liquid (18). Said nozzle further comprises a concentric cylindrical piece (11a) whose inner wall comprises a thread (11b) compatible with the reductant thread (14). The front portion of the main body is provided with a tubular extension (2) for the outlet of the liquid, positioned at an angle of approximately 30° with respect to the main body.

At the other end of the main body (7), there is a projection of cylindrical shape, of diameter 5 mm and length 1 cm, for the insertion of the schrader air valve (3), used for the pressurization and gasification of the liquid.

The valve body further comprises an inner channel (3a) that allows the passage of the gas of the air valve (3) into the container where the liquid is stored.

On the right and left sides of the main body, there are two small overlapping holes (9a) of diameter 2 mm each, with 2 mm spacing from each other. The upper orifice is used to hold the handle against the valve body during handling, so as to allow for its movement. When both the top and bottom holes are filled with the metallic rods (9c), with the handle (1) at 90° position, the flexible hose (6) is fully compressed and the valve is locked so that the beverage may be transported without danger of leakage. Both the grip of the handle (1) to the main body of the valve (7) and the full locking thereof are made by passing the metallic rods (9c), by each hole (9b) in the valve body and (9a) in the handle (1).

In the core of the upper portion of the main body of the valve there is a hollow portion of rectangular shape followed by a semi-ball (8). The handle (1) is fitted in this hollow space and a flexible hose (6) is positioned in “L”. One of the ends of said hose is in contact with the upper end of the pipe (5) and the other end open to the environment.

In one embodiment, said valve is compatible with a growler with the nozzle similar to that of a pet bottle.

In one embodiment, the body of said valve comprises an outer diameter 3.5 cm and height 3.0 cm, tubular extension of length 6 cm, diameter 4.25 mm, at an angle of approximately 30° with respect to the main body and projecting from diameter 5 mm and length 1 cm, rectangular shaped hollow portion with 4.25 mm height and 4.96 mm long, semi-ball of 8 mm diameter, inner diameter of thread diameter 7.14 mm, 2 overlapping holes of diameter 2 mm with 2 mm spacing from each other.

In one embodiment, the cylindrical piece (11a) of the valve body comprises means for coupling the reductant (4) other than a thread.

### Handle (1)

The handle according to this invention is a movable portion of said valve that enables the egress of the gasified liquid. The formation of the foam occurs according to the movement of the handle which varies 60°.

Said handle comprises a semi-ball (12) at one end through which the fitting is made in the valve body according to this invention which comprises a hollow semi-ball (8).

Said handle comprises in the semi-ball 2 small holes (9a) which correspond to other 2 small holes (9b) in the valve body. Such holes are passed through a small metal pin (9c) which allows the handle to move in a total opening of about 60° in the vertical direction.

In one embodiment, the handle according to this invention comprises 46 mm long, 11.07 mm thick having 17.15 mm semi-ball radius at one end, 2 mm diameter overlapping holes with 2 mm spacing and beveled edges throughout the piece.

Said handle is locked when it is in the vertical position 90° in relation to the ground (FIG. 9A) and with the 2 holes passed through by a metal pin. In this way, the container may be shipped without any danger of leakage of the liquid.

When said handle is moved forward in relation to the user (FIG. 9B), it allows the flow of the gasified liquid with high turbulence as in this position it has a high compression level of the flexible hose (6) that is with the inner diameter well reduced.

When the handle (1) is moved backward in relation to the user (FIG. 9C), it allows the flow of the gasified liquid with low turbulence as in this position it has a low compression level of the flexible hose (6), which then presents with increased or completely free inner diameter.

### Flexible Hose at “L” (6)

The flexible hose according to this invention is a hose positioned at “L” in the main body of the valve. Such “L” position is due to the fact that one of its ends is connected to the upper end of the pipe (5) and the other end fitted to the extension nozzle (2) of the valve body for dispensing the liquid.

The folding of said “L” occurs by passage of said hose (6) by the semi-ball of the valve body (8). Said hose is positioned between the semi-ball of the valve body (8) and the semi-ball of the end of the handle (12). Thus, during movement of the handle (1), the inner diameter of said flexible hose (6) is necessarily changed, reflecting directly in the manner as the gasified liquid is dispensed.

In one embodiment, said flexible hose is a silicone hose.

In one embodiment, said valve comprises a long “L” flexible hose that is partially submerged in the liquid and said valve does not comprise the liquid outlet pipe (5).

### Liquid Outlet Pipe (5)

The valve according to this invention comprises a pipe that remains partially immersed in the gasified liquid.

In particular, such a pipe must be sufficiently stiff to withstand the external pressure of the gas dissolved in the liquid but flexible enough to allow for the engagement of the reductants.

In one embodiment, said pipe is of silicone of outer diameter 8 mm, inner diameter 5 mm and length 30 cm.

### Reductants

The use of reductants along the liquid outlet pipe (5) allows for a more accurate control of the outflow of the beverage so as to decrease its turbulence during dispensing. Such reductants allow the valve to actuate in more fine and accurate manner in the customization of the creaminess of the beverage, i.e., in the formation of the foam.

The reductants according to this invention are devices that serve as a function to reduce the pressure of the solubilized gas in the liquid as it passes through the pipe at the time the beverage is taken to leave the less turbulent outflow. Such reductants may have various shapes and be made of different materials and may or may not be of the same shape.

The valve according to this invention comprises a reductant (4) positioned at the upper end of the liquid outlet pipe (5), so as not only to allow for the reduction of the turbulence of the liquid flow, but also to allow the connection of the liquid outlet pipe (5) to the valve body according to this invention through an outer thread (14).

Optionally, the valve according to this invention comprises a reductant (41) at the lower end of the liquid outlet pipe.

The reductant (4) comprises a rubber ring (16) which assists in the fitting of this liquid outlet pipe (5), preventing its movement with the use of the valve according to this invention.

Said reductant (4) comprises an outer thread (14) for fixation to the liquid outlet pipe (5) and the valve body (7), and said thread comprises grooves (15) which assist in threading the valve body (11b).

The reductant (4) further comprises an upper cylindrical piece (4a) in which is connected the flexible hose (6) and a lower cylindrical piece (4b) in which the liquid outlet pipe (5) is fixed by means of a simple fitting.

In one embodiment, the upper and lower cylindrical piece of the reductant has the same diameter.

In one embodiment, the lower and upper cylindrical piece has different diameters.

The reductant (4) further comprises a rubber ring for sealing (16).

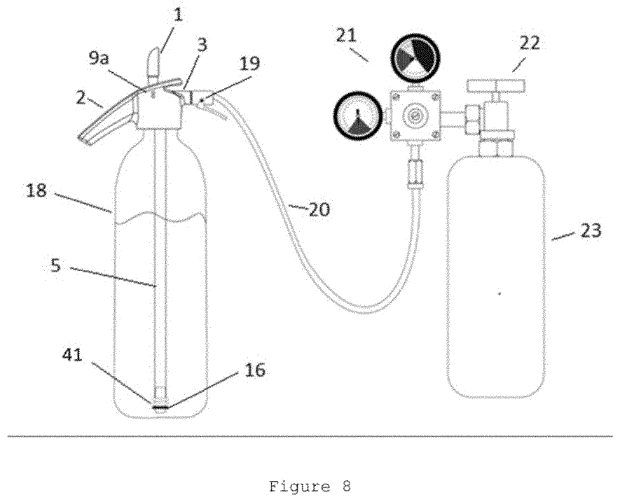

In one embodiment, the valve according to this invention comprises 2 reductants, both of inner diameter 1 mm and length 2 cm both made of metallic material, as shown in FIG. 7.

In one embodiment, the valve according to this invention has only 1 reductant (41) and a long “L” flexible hose, wherein such a reductant is positioned at the immersed end in the liquid.

### EXAMPLE OF EMBODIMENT

CLEAN SPECIFICATION

The example of use to be described relates to the use of a 2 L capacity bottle which has been filled with 1.3 L of the beverage, for example chopp, at the usual temperature of consumption.

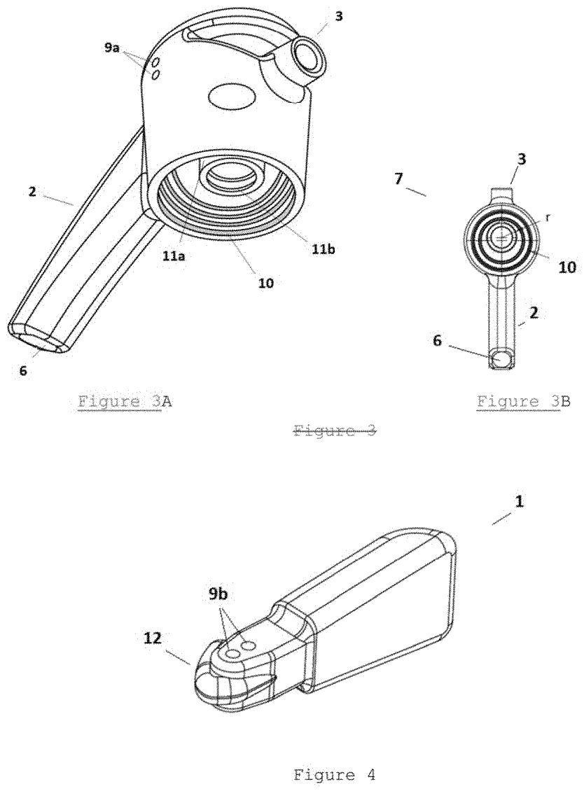

Once the bottle is filled, the valve was threaded and the preparation is made for the pressurization of the beverage gasifying system. The FIG. 3A illustrates the threaded bottom portion of the valve, the nozzle.

For the gasification and pressurization, it is necessary to connect the cylinder, CO₂ or N₂, to the bottle. To this end, a flexible hose is used, for example polypropylene (5 mm diameter), wherein one of the ends has a thread coupled to the cylinder and the other is a clamp with an air injector nozzle as used in mini-air compressors for tire, commercially available model SH-P 00004.

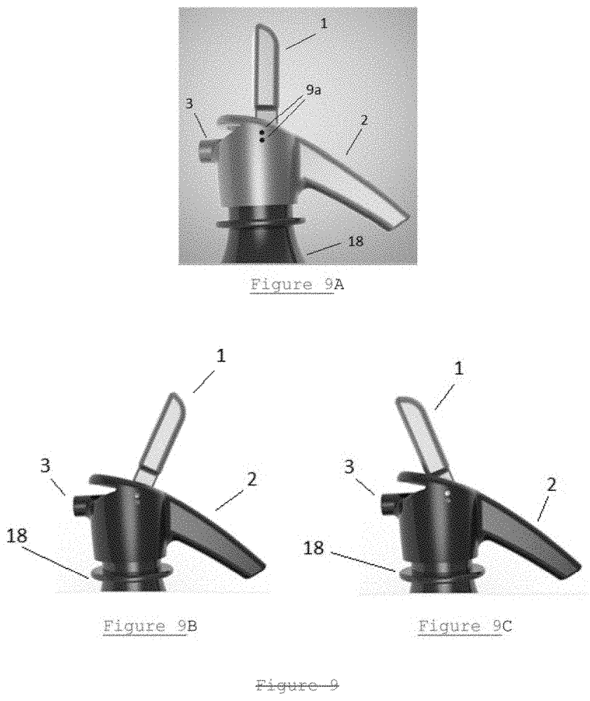

The nozzle is coupled to the main body of the valve, which comprises a schrader valve, which is used in a tubeless automobile tire, the market Model 414 R, as shown in FIGS. 7 and 8.

Since the ends are properly connected, the cylinder register (22) is opened and the pressurization starts. The gasification may be done with carbon dioxide CO₂ (99.9%), nitrogen N₂ (99.9%) or a mixture thereof. The recommended pressure is 3.5 kgf cm⁻² for 2 seconds. This procedure may be done in both the commercial establishment and the home environment, following the proper safety requirements. Once this step is finished, the cylinder register (22) is closed, the nozzle is disconnected from the bottle and dispensing of the beverage may be initiated.

For dispensing the beverage, the handle (1) of the valve according to this invention is used, in order to customize the quantity of foam of the beverage.

When in the center position, FIG. 9A, the handle is locked since it exerts maximum compression on the flexible hose, so that no liquid flows.

When the handle is moved forward in relation to the user, FIG. 9B, the hose undergoes a modification in its compression that enables a minimal opening of the inner diameter thereof, so that the flow of the beverage is turbulent, enabling the output of large quantity of foam.

When the handle is moved backward in relation to the user (FIG. 9C) the compression of the hose will be in its less compressed embodiment, i.e., more open, so that the flow of the pressurized beverage is more laminar, allowing the liquid to exit, with less quantity of foam.

1. VALVE FOR GASIFYING LIQUIDS AND DISPENSING GASIFIED LIQUIDS comprising a main body comprising an air valve interconnected to an inner channel, said valve further comprising a nozzle comprising a universal thread characterized by a flexible hose in an “L” shape which is positioned internally of the tubular extension, wherein said flexible hose is arranged between the main body and a handle which pivots with the main body through a metallic rod that passes through an upper hole, wherein the extension of said hose constitutes the outlet pipe comprising a reductant at the end of said liquid outlet pipe.

2-28. (canceled)

29. The VALVE according to claim 1, wherein said nozzle comprises a cylindrical piece which connects through means of connection to the reductant, and the reductant connects to the liquid outlet pipe and said reductant connects to said flexible hose.

30. The VALVE according to claim 29, wherein the means of connection of the liquid outlet pipe to the valve main body are by use of the reductant with an outer thread that is threaded into a cylindrical piece of the body.

31. The VALVE according to claim 29, wherein the means of connection of the liquid outlet pipe to the nozzle of the valve comprise the use of the reductant which connects to a cylindrical piece of the body.

32. The VALVE according to claim 1, comprising a locking mechanism, wherein the metallic rods pass through the upper hole and a lower hole with the handle in a 90° position.

33. The VALVE according to claim 1, wherein the handle comprises a semi-ball in a lower region.

34. The VALVE according to claim 33, wherein the main body comprises a hollow semi-ball compatible with the semi ball of the handle.

35. The VALVE according to claim 1, wherein the handle pivots to the main body in the vertical direction at a total opening angle of 60°.

36. The VALVE according to claim 1, wherein the air valve is a tubeless car tire valve.

37. The VALVE according to claim 1, wherein the reductant comprises an outer thread with grooves and a lower and upper cylindrical piece.

38. The VALVE according to claim 37, wherein the upper and lower cylindrical piece of the reductant have the same diameter.

39. A method for gasifying liquids and dispensing gasified liquids, comprising the steps of:
placing a liquid to be gasified into a suitable container with the valve according to claim 1 installed;
connecting a cylinder hose to an air valve of a valve body;
opening a cylinder register allowing the flow of gas CO₂ and N₂ or the mixture thereof from the cylinder to the liquid;
waiting for gasification time of the liquid;
closing the cylinder register; and
disconnecting the cylinder hose from the air valve, wherein the gas pressure x hollow volume of the flask is equal to or greater than 1 kgf cm⁻².

40. The method of claim 39, wherein the gas is CO₂ and the gasification time of the liquid is 2 seconds and the pressure is 3.5 kgf cm⁻².

41. The method of claim 39, wherein the gas is CO₂, and the pressure is 3.5 kgf cm⁻² in a hollow space equal to 30% of the volume of the flask.
